(19) United States
(12) Patent Application Publication
(10) Pub. No.: US 2026/0253779 A1
(43) Pub. Date: Aug. 27, 2026

(54) COIL COMPONENT

(71) Applicant: TDK Corporation, Tokyo (JP)

(72) Inventors: Hokuto Eda, Tokyo (JP); Kohei Takahashi, Tokyo (JP); Takahiro Nemoto, Tokyo (JP); Yuma Usami, Tokyo (JP); Ryota Ishikawa, Tokyo (JP)

(73) Assignee: TDK Corporation, Tokyo (JP)

(21) Appl. No.: 19/535,622

(22) Filed: Feb. 10, 2026

(30) Foreign Application Priority Data
Feb. 21, 2025 (JP) 2025-026570

(51) Int. Cl. H01F 27/23; H01F 1/06; H01F 27/02; H01F 27/29

(52) U.S. Cl. CPC H01F 27/23; H01F 1/06; H01F 27/02; H01F 27/292

(57) ABSTRACT

In a coil component, side surfaces of an element body are exposed to an outside, and on these exposed surfaces, an area ratio of a first magnetic powder is the largest. The first magnetic powder includes cobalt, which is less likely to be oxidized, and is difficult to oxidize compared to a second magnetic powder that does not include cobalt. Therefore, all of the side surfaces of the element body are difficult to oxidize as a whole surface, deterioration of the magnetic properties of the element body due to oxidation of the magnetic powder is suppressed, and in the coil component, improvement of coil characteristics such as an inductance value is realized.

### CROSS-REFERENCE TO RELATED APPLICATIONS

This application is based upon and claims the benefit of priority from Japanese Patent Application No. 2025-26570, filed on 21 February 2025, the entire contents of which are incorporated herein by reference.

### TECHNICAL FIELD

The present disclosure relates to a coil component.

### BACKGROUND

Japanese Unexamined Patent Application Publication No. 2015-26812 discloses a coil component in which a coil is disposed within an element body including magnetic powder.

### SUMMARY

In the coil component according to the related art described above, it is conceivable that the magnetic properties of the element body deteriorate as the magnetic powder exposed on the surface of the element body oxidizes, thereby causing deterioration of coil characteristics such as an inductance value.

According to various aspects of the present disclosure, a coil component with improved characteristics is provided.

A coil component according to one aspect of the present disclosure includes an element body that includes magnetic powder and has an exposed surface at least a part of which is exposed to the outside, and a coil disposed within the element body, wherein the magnetic powder of the element body is composed of first magnetic powder and residual magnetic powder other than the first magnetic powder, the first magnetic powder includes a first element that is less likely to be oxidized than elements constituting the residual magnetic powder, and regarding an area ratio of the magnetic powder on the exposed surface of the element body, an area ratio of the first magnetic powder is the largest.

### BRIEF DESCRIPTION OF THE DRAWINGS

FIG. 1 is a perspective view illustrating a coil component according to an embodiment.

FIG. 2 is a cross-sectional view illustrating the coil component of FIG. 1.

FIG. 3 is an enlarged view of a main part of the coil component of FIG. 2.

FIG. 4 is a cross-sectional view illustrating a coil component with a different configuration.

### DETAILED DESCRIPTION

Hereinafter, embodiments of the present disclosure will be described in detail with reference to the accompanying drawings. Note that in the description of the drawings, the same or corresponding elements are denoted by the same reference numerals, and redundant description is omitted.

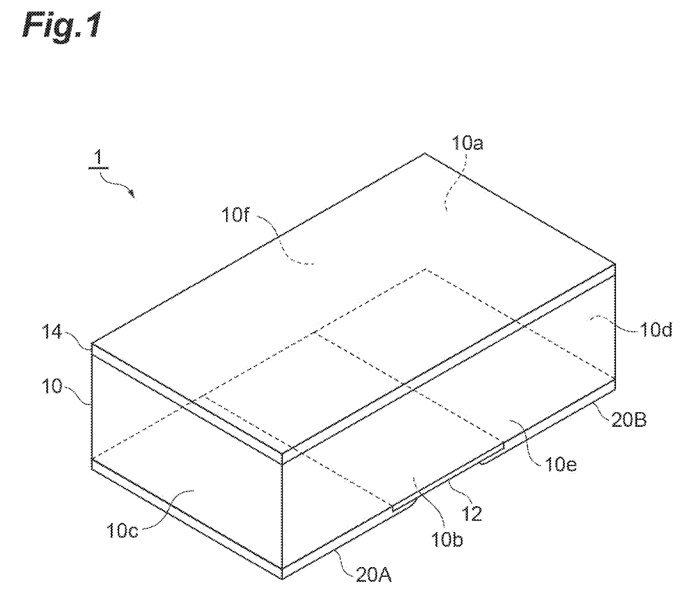

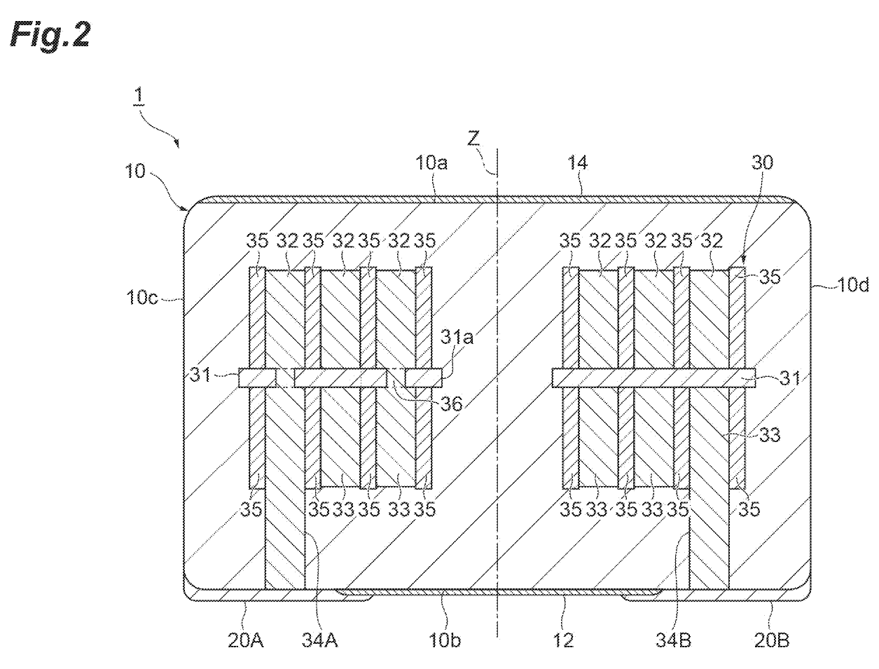

A coil component according to the present embodiment will be described with reference to FIG. 1. As illustrated in FIGS. 1 and 2, a coil component 1 according to an embodiment is configured to include an element body 10, a pair of terminal electrodes 20A and 20B, and a coil 30.

The element body 10 has a rectangular parallelepiped outer shape and has a pair of main surfaces 10a and 10b parallel to each other, and four side surfaces 10c, 10d, 10e, and 10f connecting the pair of main surfaces 10a and 10b. The rectangular parallelepiped shape in this specification includes a shape of a rectangular parallelepiped in which corner portions and ridge line portions are chamfered, and a shape of a rectangular parallelepiped in which corner portions and ridge line portions are rounded. One main surface 10b of the pair of main surfaces 10a and 10b is a surface facing a mounting substrate on which the coil component 1 is mounted, and is also referred to as a mounting surface in the following description. Each of the main surfaces 10a and 10b has a rectangular shape having a long side and a short side, and in the following description, the side surfaces 10c and 10d connecting the short sides of the main surfaces 10a and 10b are also referred to as end surfaces.

The element body 10 is composed of a magnetic powder-containing resin, which is a type of magnetic material. The magnetic powder-containing resin is a binder powder in which magnetic powder, which will be described later, is bound by a binder resin. The binder resin is, for example, a thermosetting epoxy resin. In the present embodiment, the content of the magnetic powder in the binder powder is 75 to 92 vol% in volume percent, and 95 to 99 wt% in mass percent. From the viewpoint of magnetic properties, the content of the magnetic powder in the binder powder may be 80 to 92 vol% in volume percent, and 97 to 99 wt% in mass percent.

Both of the pair of terminal electrodes 20A and 20B are provided on the mounting surface 10b of the element body 10. The terminal electrode 20A is located on one short side of the mounting surface 10b and has a rectangular shape extending along the short side over the entire length of the short side. The terminal electrode 20B is located on the other short side of the mounting surface 10b and has a rectangular shape extending along the short side over the entire length of the short side.

On the mounting surface 10b of the element body 10, a space between the pair of terminal electrodes 20A and 20B is covered by a covering material 12. That is, a region of the mounting surface 10b covered by the covering material 12 is not exposed to the outside. In the present embodiment, in the vicinity of a boundary between the terminal electrodes 20A and 20B and the covering material 12, the covering material 12 enters under the terminal electrodes 20A and 20B, that is, the terminal electrodes 20A and 20B cover an upper side of the covering material 12. The covering material 12 is composed of an insulating material such as an epoxy-based resin or an acrylic-based resin, and a short circuit between the pair of terminal electrodes 20A and 20B is prevented by the covering material 12.

The main surface 10a of the element body 10 is entirely covered by a covering material 14. That is, the entire region of the main surface 10a covered by the covering material 14 is not exposed to the outside. The covering material 14 is composed of an insulating material such as an epoxy-based resin or an acrylic-based resin. A constituent material of the covering material 14 that covers the main surface 10a may be the same as or different from a constituent material of the covering material 12 that covers the mounting surface 10b.

The coil 30 is disposed within the element body 10, as illustrated in FIG. 2. The coil 30 according to the present embodiment is wound around a coil axis Z extending in a direction orthogonal to the mounting surface 10b. The coil 30 is configured to include an insulating substrate 31, planar coils 32 and 33 provided on both surfaces of the insulating substrate 31, and a pair of extraction conductors 34A and 34B.

The insulating substrate 31 extends parallel to the mounting surface 10b, and can be disposed, for example, at an intermediate position between the mounting surface 10b and the main surface 10a. The insulating substrate 31 has a through-hole 31a at a position through which the coil axis Z passes. The insulating substrate 31 may be completely buried in the element body 10 without reaching the four side surfaces 10c, 10d, 10e, and 10f, or may reach the four side surfaces 10c, 10d, 10e, and 10f and be exposed from the four side surfaces 10c, 10d, 10e, and 10f. The insulating substrate 31 may be exposed from only some of the four side surfaces 10c, 10d, 10e, and 10f. For the insulating substrate 31, a substrate in which a glass cloth is impregnated with a cyanate resin (BT (bismaleimide-triazine) resin: registered trademark) can be used. In addition to BT resin, polyimide, aramid, epoxy, or the like can also be used. As a material for the insulating substrate 31, ceramic or glass can also be used. As the material for the insulating substrate 31, a mass-produced printed circuit board material can be used, and a resin material used for a BT printed circuit board, an FR4 printed circuit board, or an FR5 printed circuit board can be used.

The planar coil 32 is wound for a plurality of turns around the coil axis Z on a surface of the insulating substrate 31 on the main surface 10a side. An inner turn and an outer turn of the planar coil 32 are separated by a resin wall 35 provided on the insulating substrate 31. The planar coil 33 is wound around the coil axis Z on a surface of the insulating substrate 31 on the mounting surface 10b side. An inner turn and an outer turn of the planar coil 33 are also separated by a resin wall 35 provided on the insulating substrate 31, similarly to the planar coil 32.

The planar coil 32 and the planar coil 33 are connected to each other at their inner peripheral ends via a via conductor 36 provided at an edge of the through-hole 31a of the insulating substrate 31. An outer peripheral end of the planar coil 32 overlaps with the terminal electrode 20A when viewed from the main surface 10a side of the element body 10, and is connected to the terminal electrode 20A via the extraction conductor 34A extending inside the element body 10 in a direction orthogonal to the mounting surface 10b. An outer peripheral end of the planar coil 33 overlaps with the terminal electrode 20B when viewed from the main surface 10a side of the element body 10, and is connected to the terminal electrode 20B via the extraction conductor 34B extending inside the element body 10 in a direction orthogonal to the mounting surface 10b. The planar coil 32 and the planar coil 33 are wound such that current flows in the same direction (that is, the same winding direction when viewed from the main surface 10a side of the element body 10) when a voltage is applied between the pair of terminal electrodes 20A and 20B. Since current flows in the same direction in the planar coil 32 and the planar coil 33, generated magnetic fluxes are superimposed and reinforce each other.

Next, the magnetic powder of the magnetic powder-containing resin constituting the element body 10 will be described in detail.

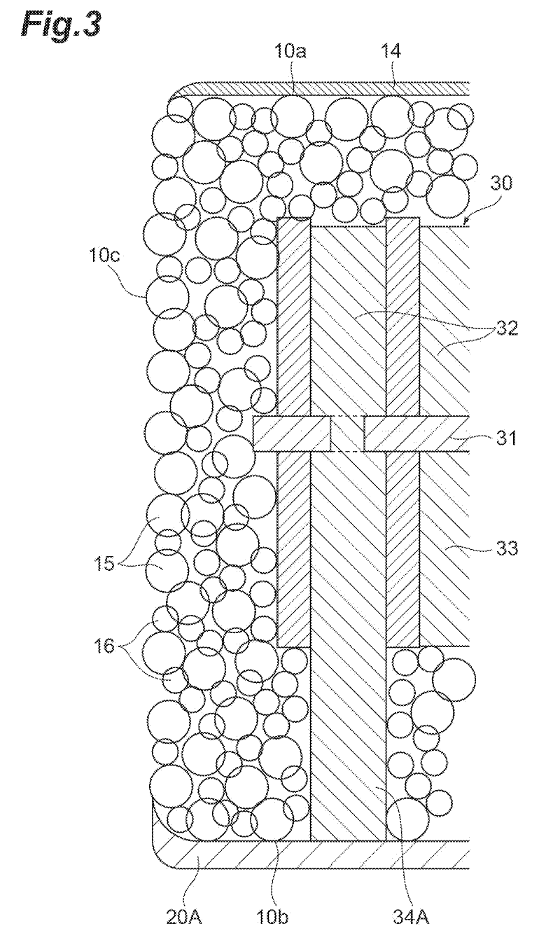

The magnetic powder of the magnetic powder-containing resin constituting the element body 10 is a mixed powder having a plurality of types of average particle diameters. In the present embodiment, the magnetic powder of the magnetic powder-containing resin constituting the element body 10 is a mixed powder of two types, a first magnetic powder 15 and a second magnetic powder 16, as illustrated in FIG. 3.

The first magnetic powder 15 has a composition including a first element that is less likely to be oxidized. In the present embodiment, the composition of the first magnetic powder 15 includes cobalt as the first element that is less likely to be oxidized, and the first magnetic powder 15 is composed of an iron-cobalt alloy (FeCo). The average particle diameter of the first magnetic powder 15 is 5 to 40 μm (for example, 25 μm). Examples of the first element include copper in addition to cobalt. When the first element is copper, the first magnetic powder 15 may be composed of a nanocrystalline alloy.

The second magnetic powder 16 does not include the above-described first element in its composition. In the present embodiment, the second magnetic powder 16 is composed of an iron-silicon alloy (FeSi). The second magnetic powder 16 is not limited to the iron-silicon alloy, and may be composed of, for example, an iron-silicon-chromium alloy (FeSiCr), a Sendust alloy (FeSiAl), Permalloy (FeNi), pure iron (Fe), carbonyl iron, or an amorphous alloy, nanocrystals, or the like. The average particle diameter of the second magnetic powder 16 is 0.1 to 5 μm (for example, 2 μm). That is, in the present embodiment, the average particle diameter of the first magnetic powder 15 is larger than the average particle diameter of the second magnetic powder 16. In other words, among all the magnetic powders of the magnetic powder-containing resin constituting the element body 10, the average particle diameter of the first magnetic powder 15 is the largest.

The magnetic powder of the magnetic powder-containing resin constituting the element body 10 constitutes at least a part of the surface of the element body 10 and is exposed on the surface of the element body 10. In the present embodiment, the side surfaces 10c, 10d, 10e, and 10f of the element body 10 are not covered with the covering materials 12, 14 and the terminal electrodes 20A and 20B, and the magnetic powder is exposed from the side surfaces 10c, 10d, 10e, and 10f of the element body 10. Hereinafter, the exposure of the magnetic powder on the end surface 10c of the element body 10 will be described with reference to FIG. 3. Regarding the exposure of the magnetic powder, the other surfaces 10d, 10e, and 10f are the same as the end surface 10c.

As illustrated in FIG. 3, the first magnetic powder 15 and the second magnetic powder 16 are exposed on the end surface 10c of the element body 10. Regarding the area ratio of the magnetic powder when viewed from the end surface 10c side, the area ratio of the first magnetic powder 15 is larger than the area ratio of the second magnetic powder 16. That is, among all the magnetic powders of the magnetic powder-containing resin constituting the element body 10, the area ratio of the first magnetic powder 15 is the largest. The area ratio of the first magnetic powder 15 is, for example, 51 to 95% (for example, 75%).

The area ratio of the first magnetic powder 15 on the end surface 10c of the element body 10 can be increased by increasing a presence ratio of the first magnetic powder 15 on the end surface 10c of the element body 10. For example, by subjecting the end surface 10c of the element body 10 to a wet etching process (for example, barrel etching), the presence ratio of the first magnetic powder 15 on the end surface 10c of the element body 10 increases. At this time, a part of the second magnetic powder 16 constituting the end surface 10c of the element body 10 is detached, whereby the presence ratio of the first magnetic powder 15 is relatively increased. In this case, the presence ratio of the first magnetic powder 15 on the end surface 10c of the element body 10 becomes higher than the presence ratio in an inner part (that is, a part not exposed to the outside) of the element body 10. The magnetic powder of the magnetic powder-containing resin constituting the element body 10 may be included in a range of 50 to 90 parts by weight for the first magnetic powder 15 and in a range of 10 to 50 parts by weight for the second magnetic powder, with respect to 100 parts by weight of the mixed powder. When a part of the second magnetic powder 16 constituting the end surface 10c of the element body 10 is detached, the detached portion becomes a recess, and unevenness can be generated on the end surface 10c. A convex portion of the end surface 10c having the unevenness is composed of the first magnetic powder 15, and on the end surface 10c, the first magnetic powder 15 protrudes to the outside more than the second magnetic powder 16.

As described above, in the coil component 1, the magnetic powder of the magnetic powder-containing resin constituting the element body 10 is composed of the first magnetic powder 15 and the residual magnetic powder other than the first magnetic powder 15 (that is, the second magnetic powder 16), the side surfaces 10c, 10d, 10e, and 10f of the element body 10 are exposed to the outside, and on these exposed surfaces, the area ratio of the first magnetic powder 15 is the largest. The first magnetic powder 15 includes cobalt, which is less likely to be oxidized, and is difficult to oxidize compared to the residual magnetic powder that does not include cobalt. Therefore, all of the side surfaces 10c, 10d, 10e, and 10f of the element body 10 are difficult to oxidize as a whole surface, deterioration of the magnetic properties of the element body 10 due to oxidation of the magnetic powder is suppressed, and in the coil component 1, improvement of coil characteristics such as an inductance value is realized.

In the above-described embodiment, the area ratio of the first magnetic powder 15 is the largest on all of the side surfaces 10c, 10d, 10e, and 10f of the element body 10, but an aspect may be adopted in which the area ratio of the first magnetic powder 15 is the largest only on some of the side surfaces (for example, only the end surfaces 10c, 10d, only the side surfaces 10e, 10f, etc.).

Further, in the above-described embodiment, the main surfaces 10a and 10b of the element body 10 are covered by the covering materials 12 and 14, and oxidation of the main surfaces 10a and 10b is suppressed by the covering materials 12 and 14. When a part or all of the main surfaces 10a and 10b of the element body 10 is exposed to the outside, by making the area ratio of the first magnetic powder 15 in the exposed region of the main surfaces 10a and 10b the largest, the exposed region becomes difficult to oxidize, similarly to the side surfaces 10c,10d, 10e, and 10f, and further improvement of the coil characteristics is achieved.

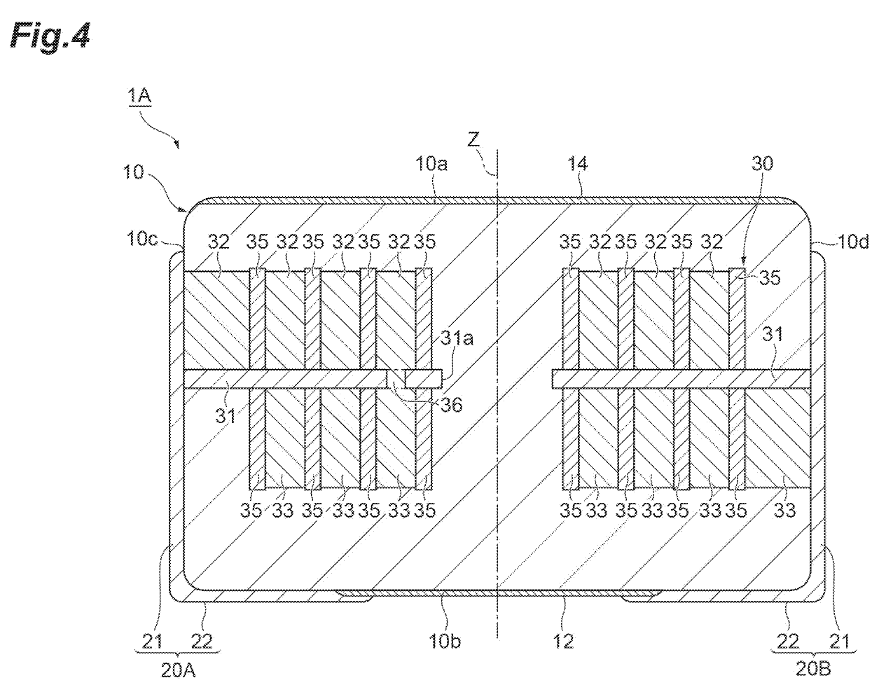

The coil component 1 is not limited to a bottom electrode type in which the terminal electrodes 20A and 20B are provided on the mounting surface 10b of the element body 10, and may be, for example, an L-shaped electrode type provided with terminal electrodes 20A and 20B that continuously cover each of the end surfaces 10c, 10d and the mounting surface 10b of the element body 10 as illustrated in FIG. 4. In the L-shaped electrode type coil component 1A illustrated in FIG. 4, the terminal electrode 20A includes an end surface covering portion 21 that covers a part of the end surface 10c of the element body and a mounting surface covering portion 22 that covers a part of the mounting surface 10b on the end surface 10c side, and the end surface covering portion 21 and the mounting surface covering portion 22 constitute an L-shaped cross section. Similarly, the terminal electrode 20B also includes an end surface covering portion 21 that covers a part of the end surface 10d of the element body and a mounting surface covering portion 22 that covers a part of the mounting surface 10b on the end surface 10d side, and the end surface covering portion 21 and the mounting surface covering portion 22 constitute an L-shaped cross section.

In the coil component 1A, both end portions of the coil 30 are extracted to the end surfaces 10c and 10d of the element body 10. Specifically, the outer peripheral end of the planar coil 32 extends to the end surface 10c and is electrically connected to the end surface covering portion 21 of the terminal electrode 20A that covers the end surface 10c. The outer peripheral end of the planar coil 33 extends to the end surface 10d and is electrically connected to the end surface covering portion 21 of the terminal electrode 20B that covers the end surface 10d.

Also in the coil component 1A, a part of the end surfaces 10c and 10d is exposed from the end surface covering portions 21 of the terminal electrodes 20A and 20B, and the area ratio of the first magnetic powder 15 in the exposed region is the largest. Therefore, the end surfaces 10c and 10d are difficult to oxidize at least in the exposed region, and improvement of the coil characteristics is achieved.

The present disclosure is not limited to the embodiments described above, and can be variously modified. For example, the magnetic powder of the magnetic powder-containing resin constituting the element body of the coil may be a mixed powder of three or more types of magnetic powders having different average particle diameters. Even in this case, regarding the area ratio of the magnetic powder on the exposed surface of the element body, the area ratio of the first magnetic powder is the largest, and the area ratio of any magnetic powder other than the first magnetic powder (residual magnetic powder) is smaller than the area ratio of the first magnetic powder. Further, among all the magnetic powders of the magnetic powder-containing resin constituting the element body, the average particle diameter of the first magnetic powder may be the largest. The coil is not limited to the form described above, and may be, for example, a form that does not include a substrate. Further, the coil may be wound around a coil axis parallel to the mounting surface.

What is claimed is:

1. A coil component comprising:
an element body including magnetic powder and having an exposed surface at least a part of the element body is exposed to an outside; and
a coil disposed in the element body,
wherein the magnetic powder of the element body is composed of a first magnetic powder and a residual magnetic powder other than the first magnetic powder,
wherein the first magnetic powder includes a first element less likely to be oxidized than elements constituting the residual magnetic powder, and
wherein an area ratio of the first magnetic powder is the largest with respect to an area ratio of the magnetic powder on the exposed surface of the element body.

2. The coil component according to claim 1, wherein the first element of the first magnetic powder is cobalt or copper.

3. The coil component according to claim 1, wherein an average particle diameter of the first magnetic powder is the largest with respect to the magnetic powder constituting the element body.

4. The coil component according to claim 1, wherein the first magnetic powder protrudes more than the residual magnetic powder on the exposed surface of the element body.

5. The coil component according to claim 1, wherein the element body has a rectangular parallelepiped outer shape and includes a mounting surface, a main surface parallel to the mounting surface, and four side surfaces connecting the mounting surface and the main surface, and the exposed surface of the element body is at least one of the four side surfaces.

6. The coil component according to claim 5, wherein the exposed surface of the element body is all of the four side surfaces.

7. The coil component according to claim 5, wherein on the mounting surface and the main surface of the element body, the area ratio of the first magnetic powder is the largest.

8. The coil component according to claim 5, wherein each of the mounting surface and the main surface of the element body is covered.

9. The coil component according to claim 5, wherein an end portion of the coil is extracted to the mounting surface of the element body.
